(19) United States
(12) Patent Application Publication
(10) Pub. No.: US 2026/0263925 A1
(43) Pub. Date: Sep. 10, 2026

(54) POSITIONING CONTROL METHOD AND SYSTEM FOR GAME LIGHT GUN, AND STORAGE MEDIUM

(71) Applicant: DASHINE ELECTRONICS CO., LTD., Shenzhen (CN)

(72) Inventors: Bintao Guo, Shenzhen (CN); Zeben Wu, Shenzhen (CN)

(21) Appl. No.: 19/663,290

(22) Filed: Apr. 30, 2026

Related U.S. Application Data
(63) Continuation of application No. PCT/CN2025/102982, filed on Jun. 24, 2025.

(30) Foreign Application Priority Data
Apr. 26, 2024 (CN) 202410513864.7

(51) Int. Cl. A63F 13/426; A63F 13/211; A63F 13/217; A63F 13/219; A63F 13/22; A63F 13/837

(52) U.S. Cl. CPC A63F 13/426; A63F 13/211; A63F 13/217; A63F 13/219; A63F 13/22; A63F 13/837; A63F 2300/1018; A63F 2300/1087; A63F 2300/8076

(57) ABSTRACT

A positioning control method and system for a game light gun, and a storage medium are provided. The positioning control method includes the following. A screen image is captured. The screen image is processed based on a neural network model to obtain a screen frame image. Initial coordinates of a crosshair of a light gun in a display screen are calculated based on the screen frame image. A current gravity direction, rotational angular velocity, and relative geomagnetic variation of the light gun are detected. Based on the gravity direction, the rotational angular velocity, and the relative geomagnetic variation, an offset of the crosshair of the light gun relative to the initial coordinates is calculated. The initial coordinates are compensated based on the offset to obtain target positioning coordinates of the crosshair of the light gun.

### CROSS-REFERENCE TO RELATED APPLICATIONS

The application is a continuation of International Application No. PCT/CN2025/102982, filed Jun. 24, 2025, which claims the benefit of Chinese Patent Application No. 202410513864.7 filed on Apr. 26, 2024, the entire disclosure of which is incorporated herein by reference.

### TECHNICAL FIELD

The present disclosure relates to the field of game equipment, and in particular, to a positioning control method and system for a game light gun, and a storage medium.

### BACKGROUND

Gaming represents an important way for people's leisure and entertainment. In shooting games, game light guns are usually required.

Currently, common game light guns include cathode ray tube (CRT) television light guns, light guns based on infrared emission and reception, and light guns based on a camera recognizing a white frame on a screen. A CRT television light gun relies on light spots on a screen. Although it has high accuracy, this technology is only applicable to CRT display technology and cannot be used with current mainstream liquid crystal and plasma displays. A light gun based on infrared emission and reception is applicable to LCD displays, but the configuration is relatively complex. Further, a precise alignment and calibration are required between an emitter and a receiver, leading to complicated operation. Although a light gun based on a camera recognizing a white frame on a screen does not require additional physical configuration, this light gun requires installation of a specific driver and is susceptible to interference from ambient light. In complex environments, the recognition rate and positioning accuracy of the white frame are relatively low, thereby affecting the stability and accuracy of the positioning of the light gun.

Based on the above, the current market of game light guns has certain limitations and deficiencies. Therefore, a new technical solution is needed to improve the performance of game light gun products, thereby enhancing user experience.

### SUMMARY

In a first aspect, an embodiment of the disclosure provides a positioning control method for a game light gun, the method includes the following. A screen image is captured. The screen image is processed based on a neural network model to obtain a screen frame image. Initial coordinates of a crosshair of a light gun in a display screen are calculated based on the screen frame image. A current gravity direction, rotational angular velocity, and relative geomagnetic variation of the light gun are detected. Based on the gravity direction, the rotational angular velocity, and the relative geomagnetic variation, an offset of the crosshair of the light gun relative to the initial coordinates is calculated. The initial coordinates are compensated based on the offset to obtain target positioning coordinates of the crosshair of the light gun.

In a second aspect, an embodiment of the disclosure provides an electronic device, adopting the following technical solution. The electronic device includes a processor and a memory storing executable codes, which, when executed by the processor, cause the processor to perform the positioning control method for a game light gun as described in any of the above.

In a third aspect, an embodiment of the disclosure provides a computer-readable storage medium, adopting the following technical solution. The computer-readable storage medium stores executable codes, which, when executed by a processor of an electronic device, cause the processor to perform the positioning control method for a game light gun as described above.

### BRIEF DESCRIPTION OF THE DRAWINGS

FIG. 1 is a schematic flowchart of a positioning control method for a game light gun provided in an embodiment of the disclosure.

FIG. 2 is a schematic diagram of a captured screen image.

FIG. 3 is a schematic diagram illustrating performing segmentation on a screen image to extract a screen frame image.

FIG. 4 is a schematic diagram illustrating performing correction on a screen frame image.

FIG. 5 is a schematic diagram illustrating determining a center point of a screen frame image.

FIG. 6 is a schematic structural diagram of a positioning control system for a game light gun provided in another embodiment of the disclosure.

### DETAILED DESCRIPTION

The terms used in the following embodiments of the disclosure are only for the purpose of describing particular embodiments and are not intended to limit the disclosure. As used in the specification and the appended claims of the disclosure, the singular forms “a”, “an”, “said”, “the”, and “this” are intended to include the plural forms as well, unless the context clearly indicates otherwise. It may be understood that the term “and/or” as used in the disclosure refers to any and all possible combinations of one or more of the listed items.

Hereinafter, the terms “first”, “second”, etc., are used for descriptive purposes only and are not to be understood as indicating or implying relative importance or implicitly indicating the number of technical features indicated. Thus, a feature defined with “first” or “second” may explicitly or implicitly include one or more of that feature. In the illustration of the embodiments of the disclosure, unless otherwise specified, “multiple” means two or more than two.

In order to solve or partially solve the problems in the above-mentioned related art, the disclosure provides a positioning control method and system for a game light gun, and a storage medium, which can improve the performance of a game light gun product, thereby enhancing user experience.

In a first aspect, an embodiment of the disclosure provides a positioning control method for a game light gun, the method includes the following. A screen image is captured. The screen image is processed based on a neural network model to obtain a screen frame image. Initial coordinates of a crosshair of a light gun in a display screen are calculated based on the screen frame image. A current gravity direction, rotational angular velocity, and relative geomagnetic variation of the light gun are detected. Based on the gravity direction, the rotational angular velocity, and the relative geomagnetic variation, an offset of the crosshair of the light gun relative to the initial coordinates is calculated. The initial coordinates are compensated based on the offset to obtain target positioning coordinates of the crosshair of the light gun.

By adopting the above technical solution, after capturing the screen image and processing the screen image based on the neural network model, a standardized screen frame image can be obtained. The initial coordinates of the crosshair of the light gun in the display screen can be calculated based on the screen frame image. By detecting the current gravity direction, the rotational angular velocity, and the relative geomagnetic variation of the light gun, the offset of the crosshair of the light gun relative to the initial coordinates can be obtained, so that the initial coordinates can be compensated and adjusted based on the offset to obtain the target positioning coordinates of the crosshair of the light gun, thereby ensuring the accuracy of the motion trajectory of the crosshair of the light gun, thus improving the accuracy of game control. Meanwhile, the solution does not need to consider issues of compatibility, configuration, or specific drivers, thereby further improving the performance of the game light gun product and thus enhancing user's gaming experience.

Optionally, processing the screen image based on the neural network model to obtain the screen frame image includes the following. Image filtering and normalization processing are performed on the screen image to obtain an optimized image. A segmentation and extraction operation is performed on the optimized image to output the screen frame image.

In the above technical solution, by performing image filtering and image normalization on the screen image, image noise can be reduced, image quality can be improved, and precise segmentation and extraction of the image can be facilitated.

Optionally, after performing the segmentation and extraction operation on the optimized image, the positioning control method for a game light gun further includes the following. The optimized image subject to the segmentation and extraction operation is corrected based on a preset standard. The preset standard includes a screen size.

In the above technical solution, by correcting, based on the screen size, the optimized image subject to the segmentation and extraction operation, subsequent precise determination of the position of the crosshair of the light gun in the screen frame image is facilitated.

Optionally, before capturing the screen image, the positioning control method for a game light gun further includes the following. Environmental detection parameters are acquired, and the environmental detection parameters include light intensity, temperature, and humidity. Parameters of a camera are automatically adjusted based on the environmental detection parameters, and the camera is located on the light gun and is configured to capture the screen image.

In the above technical solution, by acquiring the environmental detection parameters, the parameters of the camera can be automatically adjusted based on the environmental detection parameters to adapt to the current environment, ensuring the clarity of the screen image during capture.

Optionally, before acquiring the environmental detection parameters, the positioning control method for a game light gun further includes the following. Status check is automatically performed upon power-on of the light gun.

In the above technical solution, by automatically performing status check upon power-on of the light gun, it can be ensured that all components operate normally.

In a second aspect, an embodiment of the disclosure provides a positioning control system for a game light gun, including a capturing module, a processing module, a first calculation module, a detection module, a second calculation module, and a compensation module. The capturing module is configured to capture a screen image. The processing module is configured to process the screen image based on a neural network model to obtain a screen frame image. The first calculation module is configured to calculate, based on the screen frame image, initial coordinates of a crosshair of a light gun in a display screen. The detection module is configured to detect a current gravity direction, rotational angular velocity, and relative geomagnetic variation of the light gun. The second calculation module is configured to calculate, based on the gravity direction, the rotational angular velocity, and the relative geomagnetic variation, an offset of the crosshair of the light gun relative to the initial coordinates. The compensation module is configured to compensate the initial coordinates based on the offset to obtain target positioning coordinates of the crosshair of the light gun.

By adopting the above technical solution, after the capturing module captures the screen image and the processing module processes the screen image based on the neural network model, a standardized screen frame image can be obtained. The first calculation module can calculate, based on the screen frame image, the initial coordinates of the crosshair of the light gun in the display screen. The detection module detects the current gravity direction, the rotational angular velocity, and the relative geomagnetic variation of the light gun, and then the second calculation module calculates the offset of the crosshair of the light gun relative to the initial coordinates, so that the compensation module can compensate and adjust the initial coordinates based on the offset to obtain the target positioning coordinates of the crosshair of the light gun, thereby ensuring the accuracy of the motion trajectory of the crosshair of the light gun, thus improving the accuracy of game control. Meanwhile, the solution does not need to consider issues of compatibility, configuration, or specific drivers, thereby further improving the performance of the game light gun product and thus enhancing user's gaming experience.

Optionally, the processing module includes an optimization unit and an extraction unit. The optimization unit is configured to perform image filtering and normalization processing on the screen image to obtain an optimized image. The extraction unit is configured to perform a segmentation and extraction operation on the optimized image to output the screen frame image.

By adopting the above technical solution, the optimization unit can perform image filtering and image normalization on the screen image to reduce image noise and improve image quality, and then the extraction unit can facilitate precise segmentation and extraction of the image.

Optionally, the extraction unit is further configured to correct, based on a preset standard, the optimized image subject to the segmentation and extraction operation, and the preset standard includes a screen size.

In the above technical solution, by correcting, based on the screen size, the optimized image subject to the segmentation and extraction operation, accurate correction of the screen frame image can be achieved, so as to facilitate subsequent precise determination of the position of the crosshair of the light gun in the screen frame image.

In a third aspect, an embodiment of the disclosure provides an electronic device, adopting the following technical solution. The electronic device includes a processor and a memory storing executable codes, which, when executed by the processor, cause the processor to perform the positioning control method for a game light gun as described in any of the above.

In a fourth aspect, an embodiment of the disclosure provides a computer-readable storage medium, adopting the following technical solution. The computer-readable storage medium stores executable codes, which, when executed by a processor of an electronic device, cause the processor to perform the positioning control method for a game light gun as described above.

In conclusion, the disclosure includes at least one of the following beneficial technical effects.

After capturing the screen image and processing the screen image based on the neural network model, a standardized screen frame image can be obtained. The initial coordinates of the crosshair of the light gun in the display screen can be calculated based on the screen frame image. By detecting the current gravity direction, the rotational angular velocity, and the relative geomagnetic variation of the light gun, the offset of the crosshair of the light gun relative to the initial coordinates can be obtained, so that the initial coordinates can be compensated and adjusted based on the offset to obtain the target positioning coordinates of the crosshair of the light gun, thereby ensuring the accuracy of the motion trajectory of the crosshair of the light gun, thus improving the accuracy of game control. Meanwhile, the solution does not need to consider issues of compatibility, configuration, or specific drivers, thereby further improving the performance of the game light gun product and thus enhancing user's gaming experience.

By performing image filtering and image normalization on the screen image, image noise can be reduced, image quality can be improved, and precise segmentation and extraction of the image can be facilitated.

By correcting, based on the screen size, the optimized image subject to the segmentation and extraction operation, accurate correction of the screen frame image can be achieved, so as to facilitate subsequent precise determination of the position of the crosshair of the light gun in the screen frame image.

The technical solution of the embodiments of the disclosure are described in detail below with reference to the accompanying drawings.

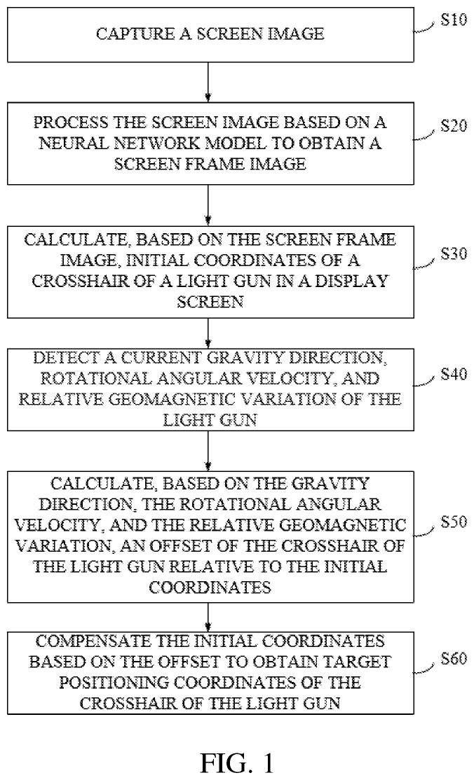

Referring to FIG. 1, a positioning control method for a game light gun is provided in an embodiment of the disclosure, which includes the following.

At S10, a screen image is captured.

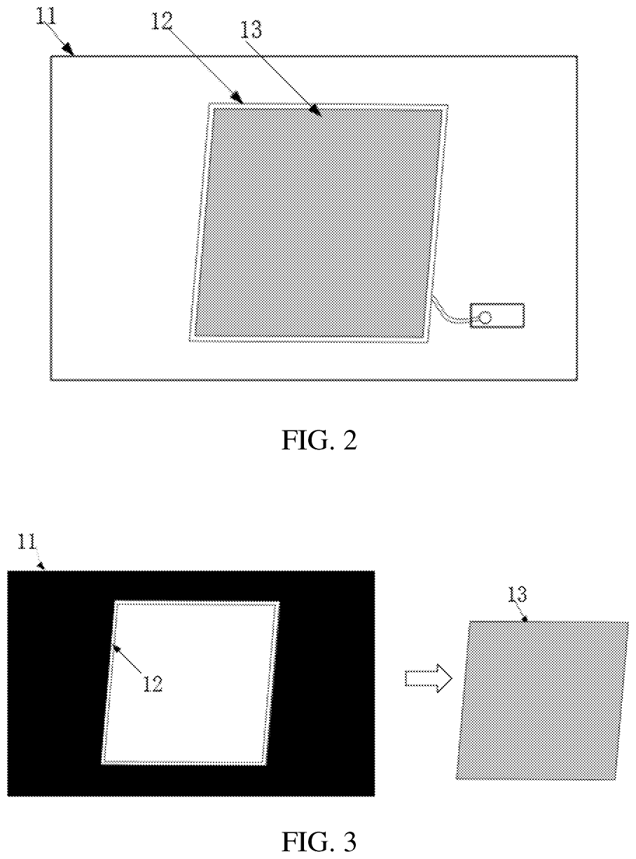

The screen image is captured in real time by a camera mounted on a game light gun, and the captured image may be as illustrated in FIG. 2. It may be noted that, the captured screen image may not only be a display screen on a display, but may include a display bezel, a power cord, a socket, or other items. The camera may be a high-definition RGB camera capable of capturing color images. However, the brand, model, etc., of the camera are not limited herein, as long as the same function and effect can be achieved.

At S20, the screen image is processed based on a neural network model to obtain a screen frame image.

Processing based on the neural network model may be understood as performing optimization according to a preset standard to improve image quality, so as to facilitate subsequent precise determination of the position of a crosshair of a light gun in the screen frame image.

In this embodiment, the operation at S20 specifically includes the following.

At S21, image filtering and normalization processing are performed on the screen image to obtain an optimized image.

The image filtering and image normalization processing are intended to reduce image noise in the screen image, so as to improve image quality.

At S22, a segmentation and extraction operation is performed on the optimized image to output a screen frame image.

The segmentation and extraction operation are intended to separate the screen picture displayed within the display bezel from other items outside the display bezel, so as to output the screen picture displayed within the display bezel, i.e., to output the screen frame image, as illustrated in FIG. 3.

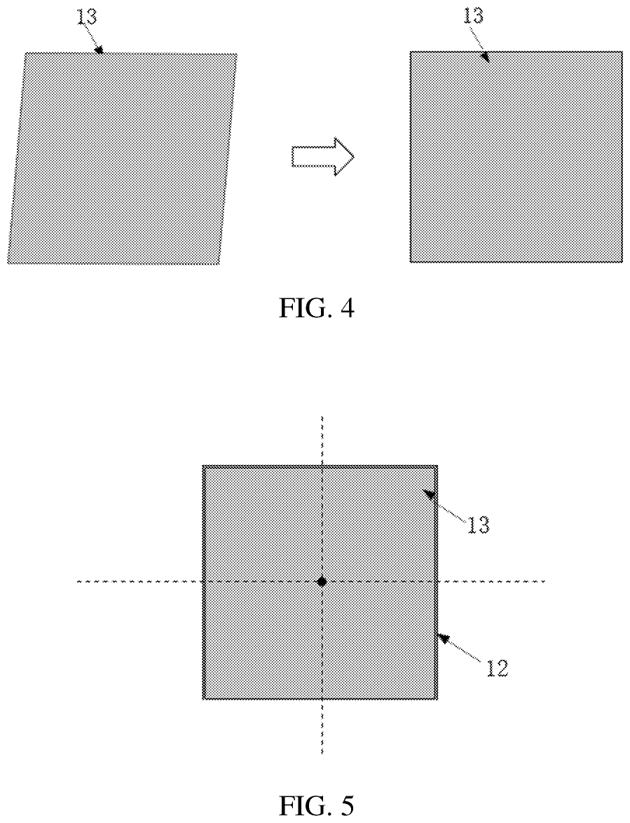

Further, after the operation at S22, the positioning control method for a game light gun further includes the following. The optimized image subject to the segmentation and extraction operation is corrected based on a preset standard. The preset standard includes a screen size, i.e., length and width data of the display, as illustrated in FIG. 4.

At S30, initial coordinates of a crosshair of a light gun in a display screen are calculated based on the screen frame image.

The determination of the initial coordinates may be performed based on an origin of a coordinate system established based on the screen frame image. The determination of the origin of the coordinate system is assumed to be preset, for example, the lower left corner of the screen frame is used as the origin of the coordinate system, which is not limited herein.

At S40, a current gravity direction, rotational angular velocity, and relative geomagnetic variation of the light gun are detected.

The movement of the light gun drives the crosshair of the light gun to move on the display. This can be understood as a process similar to the real-time movement of a mouse cursor on a computer display when moving a mouse by a hand. Regarding the acquisition of the gravity direction and rotational angular velocity, in this embodiment, a nine-axis/six-axis gyroscope may be used to measure in real time the gravity direction, the rotational angular velocity, and the relative geomagnetic variation of the light gun. Moreover, based on a nine-axis sensor fusion algorithm, data such as the movement direction, velocity, and acceleration of the light gun can be obtained.

At S50, based on the gravity direction, the rotational angular velocity, and the relative geomagnetic variation, an offset of the crosshair of the light gun relative to the initial coordinates is calculated.

The offset may be understood as the amount of error between the position of the crosshair of the light gun displayed on the display (i.e., the initial coordinates) and the actual movement position of the light gun. The nine-axis sensor fusion algorithm may be used to perform calculations on the gravity direction, the rotational angular velocity, and the relative geomagnetic variation to obtain the actual movement position of the light gun. Then, the actual movement position of the light gun is compared with the initial coordinates to calculate the offset. It may be noted that, the nine-axis sensor fusion algorithm is an existing related technology, and the relevant calculation process is not described in detail herein.

At S60, the initial coordinates are compensated based on the offset to obtain target positioning coordinates of the crosshair of the light gun.

Based on the offset, the current initial coordinates can be compensated. Furthermore, the subsequent motion trajectory can also be compensated and updated in real time, so as to ensure a precise motion trajectory of the device, thereby improving the accuracy of game control.

Specifically, when it is necessary to shoot a target, for example, to aim at the center of the display screen, the motion trajectory of the light gun may be quickly adjusted based on the offset, so as to quickly locate to the center of the display screen. The center point of the light gun in the display screen is illustrated in FIG. 5.

It may be noted that, after the game light gun is aimed at the center of the screen, the game player moves the game light gun to aim and shoot based on the screen picture seen by the naked eye. In extreme environments, such as high-temperature or low-temperature environments, the game screen seen by the naked eye of the game player may be distorted, resulting in inaccurate aiming. In this case, the system will automatically detect the current motion state of the game light gun (i.e., the offset) based on the positioning control method provided in embodiments of the disclosure, so as to timely correct the motion trajectory of the game light gun, thereby improving the aiming accuracy of the game and enhancing the player's experience.

It may be noted that, when the positioning control method of this embodiment is executed, there is no need to consider whether a running device is compatible, nor does it need to consider issues of configuration and specific drivers.

In another embodiment, before the operation at S10, the positioning control method for a game light gun further includes the following.

At S01, environmental detection parameters are acquired.

The environmental detection parameters may include light intensity, temperature, humidity, etc., and can be obtained by real-time detection through a sensor module.

At S02, parameters of a camera are automatically adjusted based on the environmental detection parameters.

The camera is located on the light gun and is configured to capture the screen image. The parameters of the camera may include exposure and focus parameters for capturing a clear image. The specific amount of adjustment of the camera parameters is not limited in this embodiment. Preset rules may be set according to actual conditions, and flexible adjustment may be performed according to the preset rules.

In another embodiment, before the operation at S01, the positioning control method for a game light gun further includes the following. Status check is automatically performed upon power-on of the light gun. By automatically performing status check upon power-on of the light gun, it can be ensured that all working components operate normally.

In conclusion, in the positioning control method for a game light gun provided in the embodiment of the disclosure, after capturing the screen image and processing the screen image based on the neural network model, a standardized screen frame image can be obtained. The initial coordinates of the crosshair of the light gun in the display screen can be calculated based on the screen frame image. By detecting the current gravity direction, the rotational angular velocity, and the relative geomagnetic variation of the light gun, the offset of the crosshair of the light gun relative to the initial coordinates can be obtained, so that the initial coordinates can be compensated and adjusted based on the offset to obtain the target positioning coordinates of the crosshair of the light gun, thereby ensuring the accuracy of the motion trajectory of the crosshair of the light gun, thus improving the accuracy of game control. Meanwhile, the solution does not need to consider issues of compatibility, configuration, or specific drivers, thereby further improving the performance of the game light gun product and thus enhancing user's gaming experience.

In addition, the reference signs of the operations in this embodiment are only for convenience of illustration and do not represent a limitation on the execution order of the operations. In practical applications, the execution order of the operations can be adjusted as needed, or they can be performed simultaneously. These adjustments or substitutions all fall within the protection scope of the disclosure.

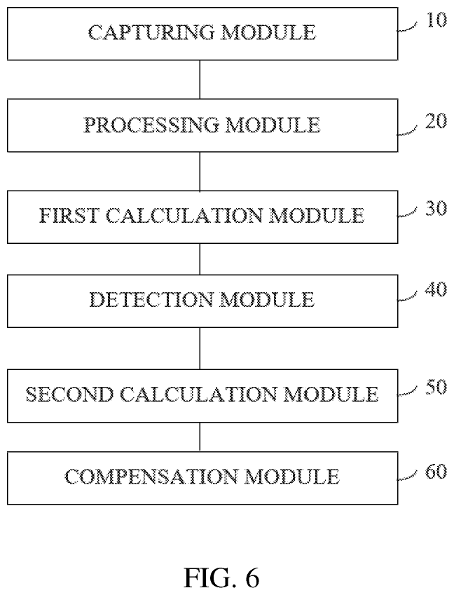

Referring to FIG. 6, a positioning control system for a game light gun is provided in another embodiment of the disclosure. The system includes a capturing module 21, a processing module 22, a first calculation module 23, a detection module 24, a second calculation module 25, and a compensation module 26.

The capturing module 21 is configured to capture a screen image. The processing module 22 is configured to process the screen image based on a neural network model to obtain a screen frame image. The first calculation module 23 is configured to calculate, based on the screen frame image, initial coordinates of a crosshair of a light gun in a display screen. The detection module 24 is configured to detect a current gravity direction, rotational angular velocity, and relative geomagnetic variation of the light gun. The second calculation module 25 is configured to calculate, based on the gravity direction, the rotational angular velocity, and the relative geomagnetic variation, an offset of the light gun relative to the initial coordinates. The compensation module 26 is configured to compensate the initial coordinates based on the offset to obtain target positioning coordinates of the crosshair of the light gun.

In another embodiment, the processing module 22 includes an optimization unit 221 and an extraction unit 222. The optimization unit 221 is configured to perform image filtering and normalization processing on the screen image to obtain an optimized image. The extraction unit 222 is configured to perform a segmentation and extraction operation on the optimized image to output the screen frame image.

In another embodiment, the extraction unit 222 is further configured to correct, based on a preset standard, the optimized image subject to the segmentation and extraction operation, and the preset standard includes a screen size.

It may be noted that, the positioning control system for a game light gun provided in the embodiment of the disclosure is used to implement the above positioning control method for a game light gun, which will not be described in detail herein.

Optionally, the various modules in this embodiment and the other operations or functions described above are respectively intended to implement the methods in the foregoing embodiments.

Another embodiment of the disclosure illustrates an electronic device, which includes a memory and a processor.

The processor may be a central processing unit (CPU), or other general-purpose processor, a digital signal processor (DSP), an application specific integrated circuit (ASIC), a field programmable gate array (FPGA), or other programmable logic device, a discrete gate or transistor logic device, a discrete hardware component, etc.

A general-purpose processor may be a microprocessor, or the processor may be any conventional processor. The memory may include various types of storage units, such as system memory, read-only memory (ROM), and a permanent storage apparatus.

The ROM may store static data or instructions required by the processor or other modules of the computer. The permanent storage apparatus may be a readable and writable storage apparatus. The permanent storage apparatus may be a non-volatile storage apparatus that does not lose stored instructions and data even when the computer is powered off. In some embodiments, a mass storage apparatus (e.g., a magnetic or optical disk, and a flash memory) is adopted as the permanent storage apparatus.

In some other embodiments, the permanent storage apparatus may be a removable storage apparatus (e.g., a floppy disk and a CD driver). The system internal memory may be a read/write storage device or a volatile read/write storage device, such as a dynamic random access internal memory. The system internal memory may store instructions and data required when some or all processors run.

In addition, the memory may include a combination of any computer-readable storage medium, including various types of semiconductor memory chips (e.g., DRAM, SRAM, SDRAM, flash memory, and/or programmable read-only memory), and magnetic disks or optical disks may also be adopted.

In some embodiments, the memory may include readable and/or writable removable storage devices, such as compact discs (CDs), read-only digital versatile discs (e.g., DVD-ROM, dual-layer DVD-ROM), read-only Blu-ray discs, ultra-density optical discs, flash memory cards (e.g., SD cards, mini SD cards, Micro-SD cards, etc.), magnetic floppy disks, etc. Computer-readable storage media do not include carrier waves and transitory electronic signals transmitted wirelessly or by wire. The memory stores executable codes, which, when processed by the processor, cause the processor to perform part or all of the methods described above.

In addition, the method according to the disclosure may be implemented as a computer program or a computer program product, and the computer program or computer program product includes computer program code instructions for executing part or all of the operations in the above method of the disclosure.

Alternatively, the disclosure may be implemented as a computer-readable storage medium (or non-transitory machine-readable storage medium or machine-readable storage medium) having stored thereon executable codes (or computer program or computer instruction code), which, when executed by a processor of an electronic device (or a server, etc.), cause the processor to perform part or all of the operations of the above method according to the disclosure.

The various embodiments of the disclosure are described above, and the above illustration is exemplary, not exhaustive, and is not limited to the disclosed embodiments. Various modifications and variations will be apparent to those of ordinary skill in the art without departing from the scope and spirit of the described embodiments. The choice of terms used herein is intended to best explain the principles, practical applications, or improvements to technologies in the market of the embodiments, or to enable other ordinary skilled in the art to understand the embodiments disclosed herein.

What is claimed is:

1. A positioning control method for a game light gun, comprising:
capturing a screen image;
processing the screen image based on a neural network model to obtain a screen frame image;
calculating, based on the screen frame image, initial coordinates of a crosshair of a light gun in a display screen;
detecting a current gravity direction, rotational angular velocity, and relative geomagnetic variation of the light gun;
calculating, based on the gravity direction, the rotational angular velocity, and the relative geomagnetic variation, an offset of the crosshair of the light gun relative to the initial coordinates; and
compensating the initial coordinates based on the offset to obtain target positioning coordinates of the crosshair of the light gun.

2. The positioning control method for a game light gun according to claim 1, wherein processing the screen image based on a neural network model to obtain a screen frame image comprises:
performing image filtering and normalization processing on the screen image to obtain an optimized image; and
performing a segmentation and extraction operation on the optimized image to output the screen frame image.

3. The positioning control method for a game light gun according to claim 2, wherein after performing the segmentation and extraction operation on the optimized image, the positioning control method for a game light gun further comprises:
correcting, based on a preset standard, the optimized image subject to the segmentation and extraction operation, wherein the preset standard comprises a screen size.

4. The positioning control method for a game light gun according to claim 1, wherein before capturing the screen image, the positioning control method for a game light gun further comprises:
acquiring environmental detection parameters, wherein the environmental detection parameters comprise light intensity, temperature, and humidity; and
automatically adjusting parameters of a camera based on the environmental detection parameters, wherein the camera is located on the light gun and is configured to capture the screen image.

5. The positioning control method for a game light gun according to claim 4, wherein before acquiring the environmental detection parameters, the positioning control method for a game light gun further comprises:
automatically performing status check upon power-on of the light gun.

6. An electronic device, comprising:
a processor; and
a memory storing executable codes, which, when executed by the processor, cause the processor to:
capture a screen image;
process the screen image based on a neural network model to obtain a screen frame image;
calculate, based on the screen frame image, initial coordinates of a crosshair of a light gun in a display screen;
detect a current gravity direction, rotational angular velocity, and relative geomagnetic variation of the light gun;
calculate, based on the gravity direction, the rotational angular velocity, and the relative geomagnetic variation, an offset of the crosshair of the light gun relative to the initial coordinates; and
compensate the initial coordinates based on the offset to obtain target positioning coordinates of the crosshair of the light gun.

7. The electronic device according to claim 6, wherein the executable codes executed by the processor to cause the processor to process the screen image based on the neural network model to obtain the screen frame image is executed by the processor to cause the processor to:
perform image filtering and normalization processing on the screen image to obtain an optimized image; and
perform a segmentation and extraction operation on the optimized image to output the screen frame image.

8. The electronic device according to claim 7, wherein the executable codes are executed by the processor to further cause the processor to:
correct, based on a preset standard, the optimized image subject to the segmentation and extraction operation, after performing the segmentation and extraction operation on the optimized image, wherein the preset standard comprises a screen size.

9. The electronic device according to claim 6, wherein the executable codes are executed by the processor to further cause the processor to:
acquire environmental detection parameters before capturing the screen image, wherein the environmental detection parameters comprise light intensity, temperature, and humidity; and
automatically adjust parameters of a camera based on the environmental detection parameters, wherein the camera is located on the light gun and is configured to capture the screen image.

10. The electronic device according to claim 9, wherein the executable codes are executed by the processor to further cause the processor to:
automatically perform status check upon power-on of the light gun before acquiring the environmental detection parameters.

11. A non-transitory computer-readable storage medium storing executable codes, which, when executed by a processor of an electronic device, cause the processor to:
capture a screen image;
process the screen image based on a neural network model to obtain a screen frame image;
calculate, based on the screen frame image, initial coordinates of a crosshair of a light gun in a display screen;
detect a current gravity direction, rotational angular velocity, and relative geomagnetic variation of the light gun;
calculate, based on the gravity direction, the rotational angular velocity, and the relative geomagnetic variation, an offset of the crosshair of the light gun relative to the initial coordinates; and
compensate the initial coordinates based on the offset to obtain target positioning coordinates of the crosshair of the light gun.

12. The non-transitory computer-readable storage medium according to claim 11, wherein the executable codes executed by the processor to cause the processor to process the screen image based on the neural network model to obtain the screen frame image is executed by the processor to cause the processor to:
perform image filtering and normalization processing on the screen image to obtain an optimized image; and
perform a segmentation and extraction operation on the optimized image to output the screen frame image.

13. The non-transitory computer-readable storage medium according to claim 12, wherein the executable codes are executed by the processor to further cause the processor to:
correct, based on a preset standard, the optimized image subject to the segmentation and extraction operation, after performing the segmentation and extraction operation on the optimized image, wherein the preset standard comprises a screen size.

14. The non-transitory computer-readable storage medium according to claim 11, wherein the executable codes are executed by the processor to further cause the processor to:
acquire environmental detection parameters before capturing the screen image, wherein the environmental detection parameters comprise light intensity, temperature, and humidity; and
automatically adjust parameters of a camera based on the environmental detection parameters, wherein the camera is located on the light gun and is configured to capture the screen image.

15. The non-transitory computer-readable storage medium according to claim 14, wherein the executable codes are executed by the processor to further cause the processor to:
automatically perform status check upon power-on of the light gun before acquiring the environmental detection parameters.
